(19) United States
(12) Patent Application Publication
(10) Pub. No.: US 2013/0238272 A1
(43) Pub. Date: Sep. 12, 2013

(54) TOUCH TRIGGER PROBE

(71) Applicants: Shi-Duang CHEN, Hsinchu City (TW); Tay-Cheng Kuo, Hsinchu City (TW)

(72) Inventors: Shi-Duang CHEN, Hsinchu City (TW); Tay-Cheng Kuo, Hsinchu City (TW)

(21) Appl. No.: 13/412,866

(22) Filed: Mar. 6, 2012

(51) Int. Cl. G01B 5/012

(52) U.S. Cl. 702/95

(57) ABSTRACT

A touch trigger probe is used to determine whether contacts with a workpiece and contains a sleeve, a sensing segment and a transmitting segment. The sleeve extends along an axial direction and includes a first chamber and a second chamber communicating with the first chamber. The sensing segment includes a sensing end extending out of the sleeve and a driving end far from the sensing end. The transmitting segment is pushed by the driving end to move in the second chamber to a triggering position from an original position relative to the sleeve, and includes a driven end protruded axially and capable of contacting with the driving end. Thereby, as the touch trigger probe of the invention has a swing sensing travel for lateral contact and an elevation sensing travel for longitudinal contact, excessive sensing elements can be avoided to lower production costs and obtain positioning precision.

### FIELD OF THE INVENTION

The present invention relates to a touch sensing device, and more particularly to a touch trigger probe to support a lateral sensing operation and a longitudinal sensing operation.

### BACKGROUND OF THE INVENTION

In an automated working process, a workpiece has to be positioned precisely so as to be worked by a machine tool accurately, so a position of the workpiece is measured by a position measuring equipment in advance.

Conventional measuring equipment for the workpiece drives a piston rod thereof to move upward and downward by air entering and discharging operation of a cylinder so as to drive an actuating member further. Since the actuating member connects with a linear slide track, when the piston rod pushes the actuating member, the linear slide track is driven to slide in a linear bearing, such that a probe below the actuating member moves upward or downward. However, such a probe is comprised of a resilient element coupled with a touch tip, and a sensing of a datum surface or a measurement of a working point for the workpiece is executed in a longitudinal contacting manner, limiting the measurement of the datum position of the workpiece and affecting the positioning accuracy. Another measuring equipment for a workpiece, such as a probe fixed on a coordinate positioning device to measure a profile of an object is disclosed in U.S. Pat. No. 7,792,654, the probe contains a touch tip, a spring box, a compression spring, an upper component, and a sensing element. The touch tip includes a pointed end to contact with an object, the upper component includes a pair of rollers, and the sensing element includes three balls in contact with the rollers. When the touch tip moves longitudinally to contact with the object via the pointed end, the compressing spring in the spring box senses the contact with the object; when the touch tip moves laterally to contact with the object through the pointed end, the upper component presses the balls by ways of the rollers, and a semiconductor strain gauge of the sensing element senses the contact with the object. Nevertheless, such a probe is complicated and is provided with excessive sensing elements to achieve a longitudinal and lateral contact sensing, causing a high production cost.

The present invention has arisen to mitigate and/or obviate the afore-described disadvantages.

### SUMMARY OF THE INVENTION

The primary object of the present invention is to provide a touch trigger probe that is capable of overcoming the shortcomings of the conventional touch trigger probe.

To obtain the above objective, a touch trigger probe provided by the present invention is used to determine whether contacts with a workpiece and contains a sleeve, a sensing segment and a transmitting segment. The sleeve extends along an axial direction and includes an opening, a first chamber communicating with the opening, and a second chamber communicating with the first chamber. The sensing segment is movably located in the first chamber and includes a sensing end extending out of the opening and a driving end far from the sensing end. The transmitting segment is mounted in the second chamber and pushed by the driving end to move to a triggering position from an original position relative to the sleeve. The sensing segment has a swing sensing travel in which the workpiece laterally pushes the sensing end to drive the driving end to tilt so that the driven end is pushed by the driving end to move the transmitting segment to the triggering position. The sensing segment also has an elevation sensing travel in which the workpiece axially pushes the sensing end to drive the driving end to move axially so that the driven end is pushed by the driving end to move the transmitting segment to the triggering position.

Thereby, as the sensing segment of the touch trigger probe of the present invention has the swing sensing travel for lateral contact and the elevation contact for longitudinal contact to push the transmitting segment to the triggering position, the location of the workpiece can be measured. Hence, not only positioning precision of the workpiece can be enhanced, but also excessive sensing elements can be avoided to lower a production cost.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a touch trigger probe according to a preferred embodiment of the present invention;

FIG. 2 is a cross sectional view showing the assembly of the touch trigger probe according to the preferred embodiment of the present invention;

FIG. 3 is a cross sectional view showing a swing sensing travel of the touch trigger probe according to the preferred embodiment of the present invention;

FIG. 4 is a cross sectional view showing an elevation sensing travel of the touch trigger probe according to the preferred embodiment of the present invention.

### DETAILED DESCRIPTION OF THE PREFERRED EMBODIMENTS

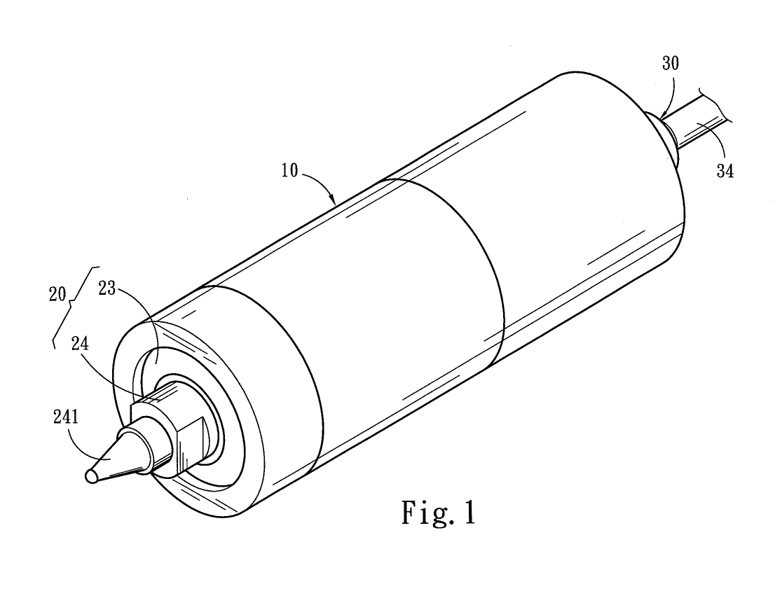

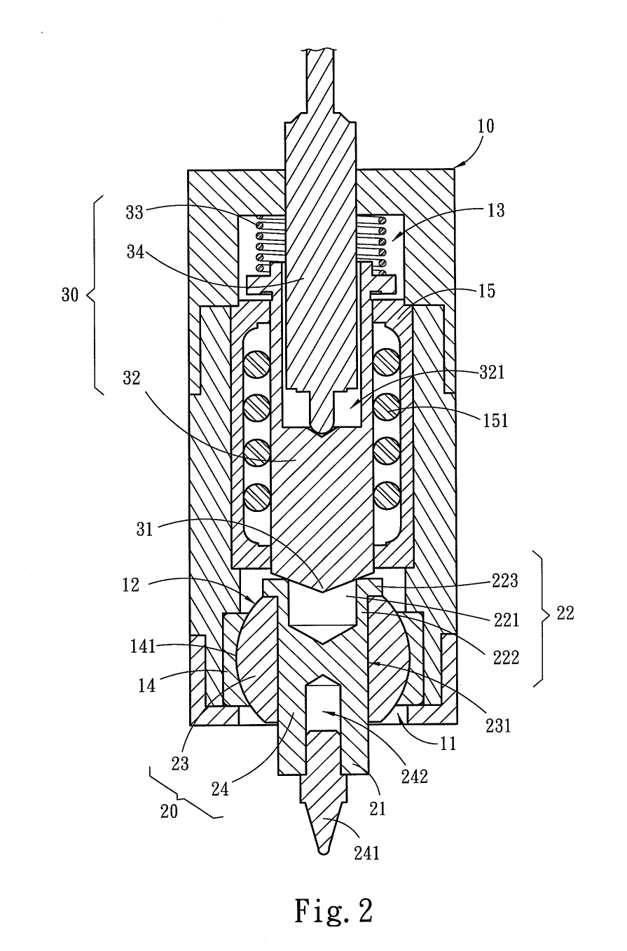

FIGS. 1 and 2 are respectively a perspective view and a cross sectional view of a touch trigger probe according to a preferred embodiment of the present invention, and the touch trigger probe is used to determine whether contacts with a workpiece (not shown in the drawings) and comprises a sleeve 10, a sensing segment 20, and a transmitting segment 30.

The sleeve 10 extends along an axial direction and is comprised of three components. The sleeve 10 includes an opening 11, a first chamber 12 communicating with the opening 11, a second chamber 13 communicating with the first chamber 12, a first clamping portion 14 and a second clamping portion 15. The first clamping portion 14 is secured on an inner wall of the sleeve 10 and is defined between the sleeve 10 and the sensing segment 20. The second clamping portion 15 is located in the second chamber 13 and also secured on the inner wall of the sleeve 10 and defined between the sleeve 10 and the transmitting segment 30.

The sensing segment 20 is movably located in the first chamber 12 and includes a holder 23 with a through hole 231 and a trigger member 24 inserted into the through hole 231. The holder 23 is covered by the first clamping portion 14 and contacts with the first clamping portion 14 to form an arcuate interface 141 and rotates universally in the first chamber 12. The trigger member 24 moves longitudinally in the through hole 231 and includes a sensing end 21 and a driving end 22. The sensing end 21 extends out of the opening 11 and has a holding groove 242 to hold a touch probe 241 in different types according to using requirements. The driving end 22 is far from the sensing end 21 and includes an annular wall 222 axially extending therearound and a recess 221 surrounded by the annular wall 222. The annular wall 222 further extends outside the through hole 231 to form a flange 223 extending outward radially and retaining on the holder 23.

The transmitting segment 30 is mounted in the second chamber 13 and is pushed by the driving end 22 to move to a triggering position from an original position relative to the sleeve 10. The transmitting segment 30 includes a transmitting member 32, a transmission rod 34, and a resilient element 33. The transmitting member 32 is covered by the second clamping portion 15, and the transmitting member 32 and the second clamping portion 15 are interposed by a plurality of rolling balls 151 to facilitate longitudinal movement of the transmitting member 32. The transmitting member 32 also includes a driven end 31 protruded axially and a slot 321 far from the driven end 31. The driven end 31 contacts with the driving end 22 and extends into the recess 221. In this embodiment, a cross section of the driven end 31 is formed in a triangle shape but not be limited to this shape, for example, it is formed in a semi-arc shape or a trapezoid shape. The transmission rod 34 is held in the slot 321 and contacts with the transmitting member 32 and extends outside the sleeve 10 from a direction far from the transmitting member 32 to trigger an external element (not shown in the drawings) to perform sensing. The resilient element 33 is located between the transmitting member 32 and the sleeve 10 and butts against the sleeve 10 to push the transmitting member 32 to contact with the driving end 22 via the driven end 31. In this embodiment, the resilient element 33 is a spring but not be limited to this spring.

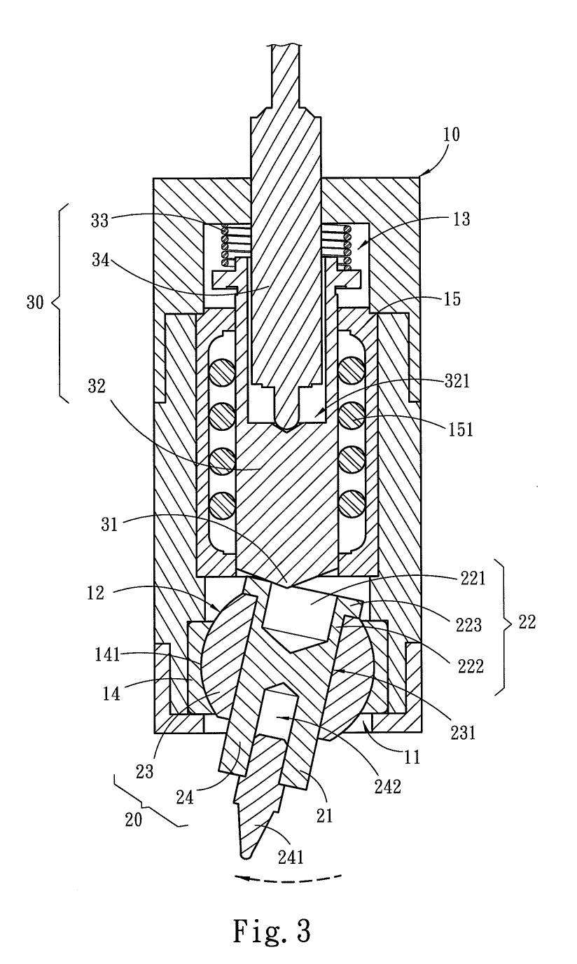

FIG. 3 shows a cross sectional view of a swing sensing travel of the touch trigger probe of the present invention. When the touch trigger probe is served to perform lateral sensing for the workpiece, the sensing segment 20 has a swing sensing travel in which the workpiece is in contact with the touch probe 241 to further push the touch probe 241 laterally so that the trigger member 24 drives the holder 23 to slide against the first clamping portion 14 on the arcuate interface 141 so as to drive the driving end 22 to tilt, and then the annular wall 222 pushes the driven end 31 so that the transmitting segment 30 moves toward the triggering position. Thereafter, the transmitting segment 30 is pushed by the annular wall 222 to move longitudinally via the transmitting member 32 and drives the transmission rod 34 to trigger the external element (not shown in the drawings) to perform sensing, thereby the swing sensing travel of the touch trigger probe is completed. It is to be noted that after the swing sensing travel is completed, the workpiece moves away from the touch probe 241 without contacting, and the resilient element 33 pushes the transmitting member 32 to return so that the trigger member 24 is pushed by the transmitting member 32 to return back to its original position to have a next sensing further.

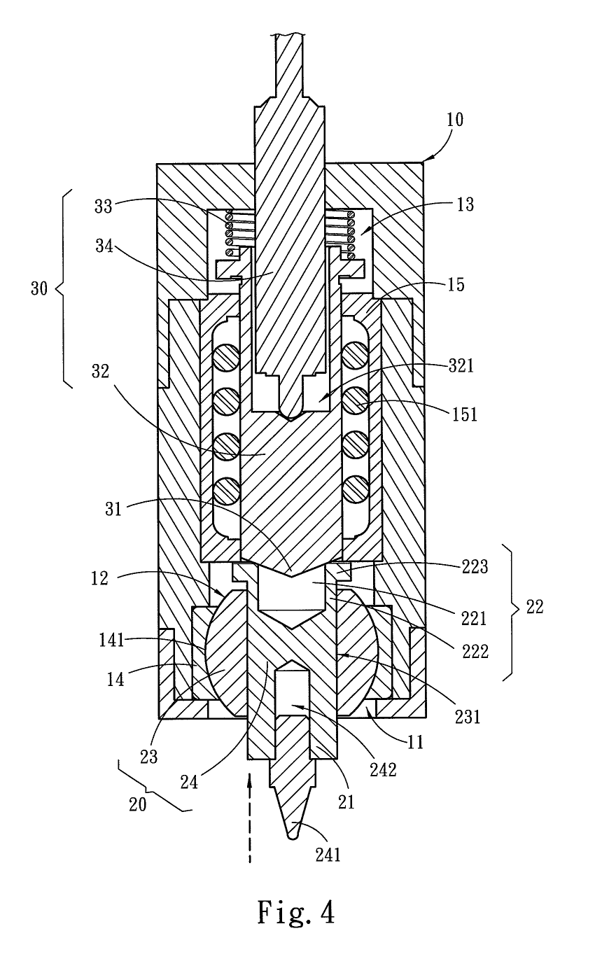

FIG. 4 shows a cross sectional of an elevation sensing travel of the touch trigger probe of the present invention. When the touch trigger probe is applied to perform longitudinal sensing for the workpiece, the sensing segment 20 has an elevation sensing travel in which the workpiece contacts with the touch probe 241 to further push the touch probe 241 longitudinally so that the trigger member 24 slides in the through hole 231 relative to the holder 23 so as to drive the driving end 22 to move axially, and then the annular wall 222 pushes the driven end 31 so that the transmitting segment 30 moves toward the triggering position. Thereafter, the transmitting segment 30 is pushed by the annular wall 222 to make the transmitting member 32 move longitudinally and to drive the transmission rod 34 to trigger the external element (not shown in the drawings) to perform sensing, thus the elevation sensing travel of the touch trigger probe is completed. It is to be noted that after the elevation sensing travel is completed, the workpiece moves away from the touch probe 241 without contacting, and the resilient element 33 pushes the transmitting member 32 to return so that the trigger member 24 is pushed by the transmitting member 32 to return back to the original position to have the next sensing further.

Thereby, as the sensing segment of the touch trigger probe of the present invention has the swing sensing travel to allow the trigger member to drive the holder to slide against the first clamping portion on the arcuate interface and has the elevation sensing travel to allow the trigger member to slide in the through hole relative to the holder, and cooperation between the driving end and the driven end, the sensing segment drives the transmitting segment to perform sensing, hence the touch trigger probe is capable of measuring a workpiece's position in a lateral contacting manner or in a longitudinal contacting manner and enhancing positioning precision of the workpiece. In addition, the touch trigger probe of the present invention is not provided with excessive sensing elements, thus lowering production cost.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A touch trigger probe used to determine whether contacts with a workpiece, comprising:
a sleeve extending along an axial direction and including an opening, a first chamber communicating with the opening, and a second chamber communicating with the first chamber;
a sensing segment movably located in the first chamber and including a sensing end extending out of the opening and a driving end far from the sensing end;
a transmitting segment mounted in the second chamber and pushed by the driving end to move to a triggering position from an original position relative to the sleeve, the transmitting segment including a driven end protruded axially and capable of contacting with the driving end;
wherein the sensing segment has a swing sensing travel in which the workpiece laterally pushes the sensing end to drive the driving end to tilt so that the driven end is pushed by the driving end to move the transmitting segment to the triggering position;
wherein the sensing segment has an elevation sensing travel in which the workpiece axially pushes the sensing end to drive the driving end to move axially so that the driven end is pushed by the driving end to move the transmitting segment to the triggering position.

2. The touch trigger probe as claimed in claim 1, wherein the sensing segment includes a holder with a through hole to rotate universally in the first chamber and includes a trigger member moving longitudinally in the through hole and including the sensing end and the driving end.

3. The touch trigger probe as claimed in claim 2, wherein the trigger member includes a holding groove in the sensing end to hold a touch probe.

4. The touch trigger probe as claimed in claim 2, wherein the driving end includes a flange extending outward radially from the through hole and retaining on the holder.

5. The touch trigger probe as claimed in claim 2, wherein the sleeve includes a first clamping portion defined between the sleeve and the sensing segment, the first clamping portion contacting with the holder to form an arcuate interface.

6. The touch trigger probe as claimed in claim 1, wherein the driving end includes a recess surrounded by an annular wall.

7. The touch trigger probe as claimed in claim 1, wherein the transmitting segment includes a transmitting member with the driven end and a resilient element located between the sleeve and the transmitting member to push the transmitting member to contact with the driving end via the driven end.

8. The touch trigger probe as claimed in claim 7, wherein the transmitting member includes a slot far from the driven end and a transmission rod held in the slot and extended outside the sleeve.

9. The touch trigger probe as claimed in claim 7, wherein the sleeve further includes a second clamping portion defined between the sleeve and the transmitting member, the transmitting member and the second clamping portion being interposed by a plurality of rolling balls to facilitate longitudinal movement of the transmitting member.
